(19) United States
(12) Patent Application Publication
(10) Pub. No.: US 2025/0381701 A1
(43) Pub. Date: Dec. 18, 2025

(54) METHOD FOR SLICING FOOD PRODUCTS AND SLICING MACHINE

(71) Applicant: MULTIVAC SEPP HAGGENMÜLLER SE & CO. KG, Wolfertschwenden (DE)

(72) Inventor: Jürgen EIDELLOTH, Wolfertschwenden (DE)

(73) Assignee: MULTIVAC SEPP HAGGENMÜLLER SE & CO. KG, Wolfertschwenden (DE)

(21) Appl. No.: 19/236,537

(22) Filed: Jun. 12, 2025

(30) Foreign Application Priority Data
Jun. 12, 2024 (DE) 102024116419.0

(51) Int. Cl. B26D 7/28; B26D 1/28; B26D 3/16; B26D 7/01

(52) U.S. Cl. CPC B26D 7/28; B26D 1/285; B26D 3/161; B26D 7/01; B26D 2007/013; B26D 2210/02

(57) ABSTRACT

The disclosure relates to a method for slicing food products formed as product calibers using a slicing machine, comprising: arranging multiple product calibers on a feeding unit, wherein at least two of the product calibers have different lengths, feeding, by the feeding unit, the at least two product calibers along a feeding direction to a cutting unit, and slicing, by the cutting unit, the at least two product calibers into slices to form portions, wherein each portion comprises one or more slices. The method further comprises determining, based on length of at least two product calibers a first slice thickness for a first product caliber of the at least two product calibers and a second slice thickness for a second product caliber of the at least two product calibers, wherein the first product caliber before slicing has a greater length than the second product caliber, and wherein the first slice thickness is determined to be greater than the second slice thickness, so that after slicing an equal number of portions from the first product caliber and the second product caliber a length difference between the first product caliber and the second product caliber is less than before slicing. The disclosure further relates to a slicing machine.

### CROSS-REFERENCE TO RELATED APPLICATIONS

This application claims foreign priority benefits under 35 U.S.C. § 119 (a)-(d) to German patent application number DE 102024116419.0, filed Jun. 12, 2024, which is incorporated by reference in its entirety.

### SUMMARY

The disclosure relates to a method for slicing food products in the form of product calibers using a slicing machine, the method comprising the following steps: arranging at least two product calibers on a feeding unit of the slicing machine, wherein at least two of the at least two product calibers have different lengths, feeding, by means of the feeding unit, the at least two product calibers along a feeding direction to a cutting unit of the slicing machine, and slicing, by means of the cutting unit, the at least two product calibers into slices to form portions, wherein each portion comprises one or more slices. The disclosure also relates to a slicing machine.

At this point, it should already be noted that the method and/or the slicing machine according to the disclosure is intended to slice food products in the form of so-called product calibers (e.g., elongated products) into slices, from which portions, preferably shingled, slice-folded, or stacked, can be formed, each consisting of one or more slices. The product calibers can, for example, be formed from sausage, cheese, cultivated meat, pressed meat and so on. The feeding unit can, for example, be designed as an endlessly circulating conveyor belt or similar. Preferably, the cutting unit is arranged downstream of the feeding unit with respect to the feeding direction. The cutting unit may comprise a blade, which can be driven to rotate around a rotational axis by means of a drive unit, for example, an electric one. By means of the blade, the slices can be separated from an end of a respective product caliber facing the cutting unit.

If multiple product calibers are to be sliced simultaneously, for example, side by side on multiple tracks of the feeding unit, it is generally necessary in known methods and slicing machines to perform so-called trimming cuts before slicing the product calibers to bring unequally long product calibers to the same length. If such trimming cuts are not carried out, unequal product calibers may result in:
a) if, along the same route and recording of the product calibers on a gripping level, complete sliced portions of longer product calibers are already created, while portions from the shorter blanks cannot yet be formed, and
b) when no portions are created from shorter blanks, while portions are still formed from longer blanks, due to variable travel distances and the recording of product calibers on different gripping levels (product length compensation on the gripper).

If the slicing method is nevertheless continued until the longer product caliber is essentially completely sliced, it can consequently result in no portions being sliced on the track with the shorter product caliber for a period of time. If a packaging machine with a number of tracks corresponding to that of the slicer is downstream of a slicer, it may occur that on the track or tracks where no slices are temporarily sliced, so-called empty packages are produced, in which there are no slices or portions. Such empty packages must subsequently be sorted out and consequently lead to reduced effectiveness and/or throughput of the method and/or the slicing machine.

Furthermore, in such trimming cuts, segments of product calibers are produced, which generally can no longer be used for slicing into slices.

It is therefore an object of the disclosure to provide a remedy, in particular by providing a method by which at least two product calibers, which have unequal lengths prior to slicing, can be cut essentially simultaneously in a suitable manner, in particular without requiring extensive trimming cuts to equalize the lengths of the at least two product calibers. Furthermore, it is the object of the disclosure to provide a corresponding slicing machine.

This object is achieved according to the disclosure by a method of the initially mentioned type, which further comprises: determining, based on the length of at least two product calibers, particularly by means of a control unit of the slicing machine, a first slice thickness for a first product caliber of the at least two product calibers and a second slice thickness for a second product caliber of the at least two product calibers, wherein the first product caliber has a greater length before slicing than the second product caliber, and wherein the first slice thickness is determined to be greater than the second slice thickness, so that after slicing an equal number of portions from the first product caliber and the second product caliber, a length difference between the first product caliber and the second product caliber is smaller than before slicing.

The product calibers can also be referred to as slicing blanks.

Since, according to the disclosure, the first and second product calibers exhibit a smaller length difference after slicing the same number of portions than before slicing, it can be ensured that, even with product calibers of different lengths before slicing, the best possible yield can be achieved for each product caliber, which is also referred to in professional circles as “yield.” By specifying a greater slice thickness for the first, longer product caliber than for the second, shorter product caliber, the lengths of the first and second product calibers approach each other during slicing, so that extensive trimming cuts do not need to be performed before slicing to bring differently long product calibers to the same length.

Nevertheless, before slicing open, at least an end piece—which may have a shorter length than a trimming piece removed by means of a trim cut—can be cut off from a respective product caliber, provided it has a tapering cross-section at at least one end, as is known, for instance, from sausage or salami or similar, which have a sausage casing or some other wrapping.

According to one exemplary embodiment, after slicing the same number of portions from the first product caliber and the second product caliber, the first product caliber and the second product caliber can be essentially completely sliced. The product calibers are essentially completely sliced preferably when they only have a predetermined remaining length, from which no further slicing of slices should or can occur. Preferably, the first, longer product caliber and the second, shorter product caliber have essentially the same length after cutting the same number of portions.

In further development of the above exemplary embodiment, the first product caliber and the second product caliber can be essentially completely sliced at the same time. If the first product caliber and the second product caliber are essentially completely sliced open at essentially the same time, a condition can be prevented in which slices and/or portions can only be sliced open on a part of adjacent tracks of the feeding unit. Consequently, the formation of so-called “empty packages,” which can occur on tracks where temporarily no slices and thus portions are cut, can preferably be completely prevented. Preferably, all traces of the feeding unit can consequently be loaded with new product calibers simultaneously, after the at least two product calibers are completely cut open.

Additionally or alternatively, the first slice thickness and the second slice thickness can be determined such that all portions cut from the at least two product calibers have an actual portion weight that deviates from a target portion weight by no more than a predetermined variance. This ensures that despite the adjustment of the first slice thickness and/or the second slice thickness, only portions are sliced that meet legal or other requirements regarding the actual portion weight of a respective portion. The predetermined deviation can be a positive and/or a negative deviation from the target portion weight. From this, for example, an upper and/or lower portion weight limit for a respective portion can be determined.

According to another exemplary embodiment, the first slice thickness can be determined to be greater than the second slice thickness only for a subsection of the first, i.e., longer, product caliber, and for a remaining section of the first product caliber, which corresponds to the total length of the first product caliber, preferably before slicing, minus a length of the subsection, the first slice thickness can be set to be identical or substantially identical to the second slice thickness. The slice thicknesses can thus, for example, only differ over the partial section, and for the remaining section, the first slice thickness and the second slice thickness, preferably the slice thicknesses of all tracks of the feeding unit, can be identical. This ensures that when slicing the remaining section, the portions sliced from the first, longer product caliber can preferably also have essentially the same actual portion weight as the portions sliced from the second, shorter product caliber.

According to further training, it is conceivable that, after slicing open the subsection, the at least two product calibers exhibit essentially the same length. The at least two product calibers are therefore preferably only sliced with different slice thicknesses as long as they have different lengths and can otherwise be sliced with the same slice thickness.

In order to determine the number of portions, preferably for each of the at least two product calibers, before slicing the product calibers, it is proposed according to another exemplary embodiment that before slicing the at least two product calibers, the number of portions is determined based on the length, and preferably the weight, of the at least two product calibers, into which the at least two product calibers are to be sliced, so that each portion has a predetermined target portion weight or at most a predetermined deviation from it.

According to a further development of this exemplary embodiment, the number of portions into which at least two product calibers are to be sliced can also be determined taking into account an average of an actual portion weight of a plurality of portions or all portions that have been sliced in the past, but preferably within the same production batch. In other words, a current average portion weight of a production batch can be taken into account, which includes, for example, all portions that are sliced or have been sliced within a specified production period, such as a workday.

According to another preferred development, the number of portions into which the at least two product calibers are to be sliced can be increased if the average actual portion weight is higher than the predetermined target portion weight, and/or the number of portions into which the at least two product calibers are to be sliced can be reduced if the average actual portion weight is lower than the predetermined target portion weight.

This ensures that the so-called “give-away” is minimized and at the same time ensures that the average actual portion weight of all portions sliced within a production batch comes as close as possible to the predetermined target portion weight. If it is determined during the slicing of a production batch that the average of the actual portion weights at a certain point in time is higher than intended, the number of portions for at least one product caliber can be increased so that each portion has a lower actual portion weight, in order to approximate the average to the target portion weight. If, during the slicing of a production batch, it is determined that the average actual portion weights at a given point in time are lower than intended, the number of portions for at least one product caliber can be reduced, so that each sliced portion has a higher actual portion weight, in order to approximate the average to the target portion weight.

In principle, the length and/or weight of a respective product caliber can be manually specified, for example, via a user interface connected to the control unit. Preferably, however, these should be determined at or immediately before the slicing machine. According to another exemplary embodiment, it is therefore proposed that, before or during the feeding, a length and/or, by means of a weighing unit, a weight of the at least two product calibers is determined by means of a length measuring unit. Provided that only the length is determined, the weight of a respective product caliber can also be determined if the density and cross-section are known.

According to another aspect, the above object is achieved by a slicing machine, in particular a slicer, for slicing food products in the form of product calibers, the slicing machine comprising a feeding unit, which is configured to individually feed at least two product calibers on adjacent tracks of the feeding unit along a feeding direction for each track, a cutting unit, which is configured to slice the at least two product calibers into slices, a portioning unit, which is configured to form portions from the slices cut by the cutting unit, with each portion comprising one or more slices, and a control unit, which is configured to control at least the feeding unit, the cutting unit, and the portioning unit, wherein the slicing machine is designed and intended to carry out the method according to the disclosure described above.

With regard to the advantages and effects of the slicing machine according to the disclosure, reference is made to the advantages and effects of the method according to the disclosure. All statements described in relation to the procedure also apply to the slicer and vice versa.

In this context, the slicing machine may preferably further comprise a gripping unit with at least one gripper in a known manner, wherein each gripper can be configured to grip one product caliber of the at least two product calibers at its end facing away from the cutting unit.

In order to be able to discharge the slices and/or portions for further processing, particularly for packaging, the portioning unit can further be configured to discharge the portions sliced by the cutting unit along a discharge direction to a loading unit, which can be configured to feed the portions to a further processing device, particularly a packaging machine.

According to further training, the insertion unit can be designed as a band inserter, by means of which multiple portions, in particular a portion format consisting of one or more portion rows and/or one or more portion columns, can be inserted into packaging at the packaging machine simultaneously.

### BRIEF DESCRIPTION OF THE DRAWINGS

The disclosure will be explained in more detail below with reference to the accompanying drawing by means of an exemplary embodiment. Figures:

FIG. 1 shows a schematic and simplified side view of a multi-track slicing machine according to the disclosure according to one exemplary embodiment; and

FIG. 2 shows a schematic and simplified top view of the slicing machine according to FIG. 1.

### DETAILED DESCRIPTION

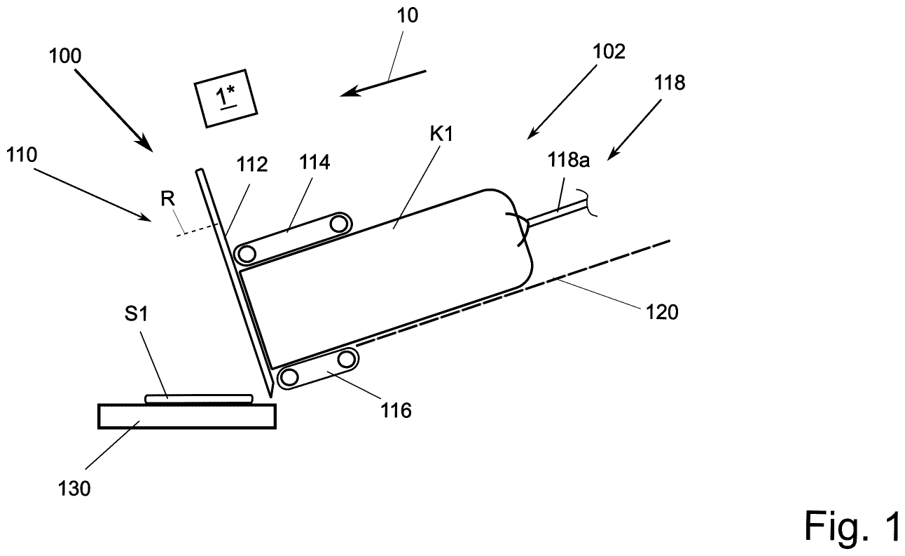

In FIG. 1, a slicing machine according to the disclosure is generally designated by reference numeral 100 according to an exemplary embodiment.

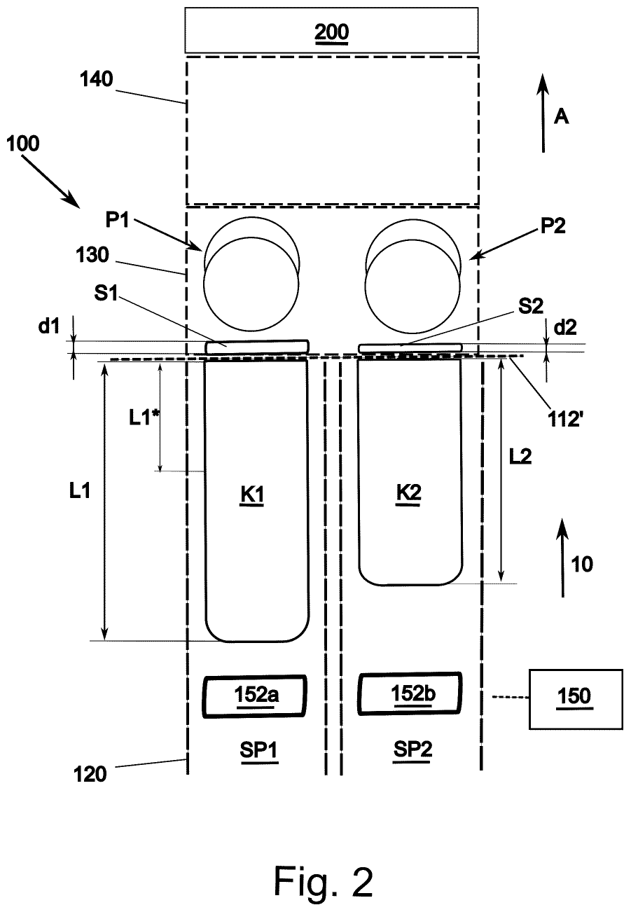

The slicer 100 can be designed as a multi-track slicer, which in the present exemplary embodiment, for example, has two tracks SP1 and SP2 (see FIG. 2). Alternatively, the slicing machine 100 can, however, have any higher number of tracks. The slicer 100 includes a feeding unit 102, which is designed to feed product calibers K1, K2 along a feeding direction 10 to a cutting unit 110. The cutting unit 110 may include a blade 112, which can be driven to rotate around a rotational axis R, for example, by means of an electric drive unit (not shown). The blade 112 can, for example, be designed as a sickle blade, which preferably has a radius varying around the rotation axis R, in particular increasing in the direction of rotation around the rotation axis R. Consequently, the blade 112 can initially release a cutting gap with a partial rotation about the rotation axis R, allowing advancement of the product caliber K1 or K2 in the feeding direction 10, and with a further rotation about the rotation axis R, separate a disc S1 (see FIG. 1) or S2 from the product caliber K1 or K2. Preferably, during each rotation of the blade 112 around the rotation axis R, both a slice S1 and a slice S2 (see FIG. 2) can be separated.

At a front end, each of the product calibers K1, K2 can be guided by an upper traction band 114 and/or a lower traction band 116. The upper traction belt 114 and/or the lower traction belt 116 can preferably be driven separately per track, i.e., in the illustrated exemplary embodiment for each track SP1 and SP2. However, it is generally sufficient if at least one of the upper traction belt 114 and the lower traction belt 116 is capable of being driven in and preferably counter to the feeding direction 10. Furthermore, the slicing machine 100 may include a gripping unit 118, which may be configured to grip the product calibers K1, K2 at an end opposite to the cutting unit 110. In this context, a single or separate gripper of the gripping unit 118 can be provided for each product caliber K1, K2, wherein in FIG. 1 only one gripper 118a of the gripping unit 118 is visible.

Before and during the slicing, the product calibers K1, K2 can rest on a feeder 120, which may be designed as a belt conveyor and is also depicted schematically in FIGS. 1 and 2.

Furthermore, in FIG. 1, a control unit 1* of the slicing machine 100 is schematically indicated, by means of which the cutting unit 110 and the feeding unit 102 of the slicing machine 100, as well as preferably all other movable parts of the slicing machine 100, can be controlled. The upper traction belt 114, the lower traction belt 116, the feeder 120, and the gripping unit 118 can be assigned to the feeding unit 102.

In FIG. 2, the product calibers K1, K2 are now arranged on the feeder 120 of the feeding unit 102. The product caliber K1 represents a first product caliber, while the product caliber K2 represents a second product caliber. In FIG. 2, a cutting plane 112′ of the blade 112 is merely indicated schematically by dashed lines. By means of the blade 112, slices S1 or S2 can be cut from the product caliber K1 or K2 respectively, through a rotational movement along the cutting plane 112′. The slices S1 and S2 can then fall onto a portioning unit 130, such as a portioning conveyor belt. For example, by stacking or shingling multiple slices S1 or S2, corresponding portions P1 or P2 can be formed on the portioning unit 130. From there, the portions P1 and P2 can be conveyed along a discharge direction A to a feeding unit or loading unit in the form of a belt feeder or belt loader 140, which may be configured to supply the portions P1 and P2 to a downstream processing device in the form of a packaging machine 200, which is also merely schematically indicated in FIG. 2.

As can be seen in FIG. 2, the first product caliber K1 and the second product caliber K2 have different lengths according to the disclosure. In the present case, the product caliber K1 has a length L1, which is greater than a length L2 of the second product caliber K2.

To at least partially compensate for this length difference between product calibers K1 and K2, the disclosure proposes that the first product caliber K1 be at least partially sliced with a first slice thickness d1, which is greater than a slice thickness d2 for the second product caliber K2. As a consequence, after slicing the same number of portions P1 and P2 from the first product caliber K1 and the second product caliber K2, a length difference between the first product caliber K1 and the second product caliber K2 may be smaller than before slicing.

Preferably, after slicing the same number of portions P1 and P2 from the first product caliber K1 and the second product caliber K2, the first product caliber K1 and the second product caliber K2 can be essentially completely cut.

It should be noted that in FIG. 2, the grippers of the gripping unit 118 are not depicted, but the product calibers K1 and K2 can each be held by a gripper. By choosing the first slice thickness d1 to be greater than the second slice thickness d2, the portions P1 can have a greater weight than the portions P2. Preferably, the first slice thickness S1 and the second slice thickness S2 are determined in such a way that all portions P1 and P2 have an actual portion weight that deviates from a target portion weight by at most a predetermined amount. If the target portion weight of a portion P1 or P2 is, for example, 100 g, then, assuming a deviation of 4.5%, the actual portion weight of a portion P1 or P2 may be a maximum of 104.5 g and a minimum of 95.5 g.

Furthermore, it can be stipulated that the first slice thickness d1 is determined to be greater than the second slice thickness S2 only for a subsection L1* of the first product caliber K1, and for a remaining section of the product caliber K1, the first slice thickness d1 and the second slice thickness d2 can be specified to be essentially identical.

The length of the segment L1* is preferably determined, for example by means of the control unit 1*, in such a way that after cutting the segment L1*, the two product calibers K1, K2 essentially have the same length. In order to determine the number of portions P1 or P2 that can be sliced from a respective product caliber K1 or K2, the slicing machine 100 may further include a length measuring unit 150 and/or weighing units 152a or 152b. In the illustrated exemplary embodiment, the weighing unit 152a is assigned to the first track SP1, while the weighing unit 152b is assigned to the second track SP2.

In principle, when slicing product calibers K1 or K2, it is conceivable to consider not only the target weight of a single portion P1 or P2, but also to take into account an average actual portion weight of a plurality of portions P1, P2, or all portions P1, P2 that have been sliced within the same production batch. If, for example, the portions P1 or P2 are to come as close as possible to the target portion weight of 100 g on average, it can be considered what average value the slices sliced in a comparison period, i.e., for example, a production batch, exhibit. If, for example, this average exceeds the target portion weight of 100 g, it is justifiable to slice portions P1 or P2 for a certain period, which have an actual portion weight less than the target portion weight, in order to approximate the average to the target portion weight. This can be achieved by increasing the number of portions P1 or P2 into which at least the two product calibers K1, K2 are to be sliced. A higher number of portions P1, P2 is achieved, for example, by reducing the slice thickness d1 or d2 of at least one of the two product calibers K1 or K2.

In the reverse case, the number of portions P1 or P2, into which the at least two product calibers K1 or K2 are to be sliced, can be reduced in an analogous manner, for example, by increasing the slice thickness d1 or d2, provided that the average of the actual portion weight is less than the predetermined target portion weight. In both cases, it can be achieved that the average within a comparison period, i.e., for example, within a production batch, approximates the target portion weight as closely as possible.

As one skilled in the art would understand, the control unit 1*, the measuring unit 150, the weighing units 152a, 152b, as well as any other control, controller, unit, system, subsystem, sensor, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof and for performing the particular algorithm or algorithms represented by the various methods, functions and/or operations described herein, including interaction between and/or cooperation with each other. One or more of such processors, as well as other circuitry and/or hardware, may be included in a single Application-Specific Integrated Circuitry (ASIC), or several processors and various circuitry and/or hardware may be distributed among several separate components, whether individually packaged or assembled into a System-on-a-Chip (SoC).

What is claimed is:

1. A method for slicing food products formed as product calibers using a slicing machine, wherein the method comprises:
arranging multiple product calibers on a feeding unit of the slicing machine, wherein at least two of the product calibers have a different length from each other;
feeding, by the feeding unit, the at least two product calibers along a feeding direction to a cutting unit of the slicing machine;
slicing, by the cutting unit, the at least two product calibers into slices to form portions, wherein each portion comprises one or more slices; and
determining by a control unit of the slicing machine, based on the length of the at least two product calibers, a first slice thickness for a first product caliber of the at least two product calibers and a second slice thickness for a second product caliber of the at least two product calibers;
wherein the first product caliber has a greater length before slicing than the second product caliber; and
wherein the first slice thickness is determined to be greater than the second slice thickness, so that after slicing an equal number of portions from the first product caliber and the second product caliber, a length difference between the first product caliber and the second product caliber is less than before slicing.

2. The method according to claim 1, wherein after slicing a same number of portions from the first product caliber and the second product caliber, the first product caliber and the second product caliber are essentially completely sliced.

3. The method according to claim 2, wherein the first product caliber and the second product caliber are substantially simultaneously completely sliced open.

4. The method according to claim 1, wherein the first slice thickness and the second slice thickness are determined such that all portions sliced from the at least two product calibers have an actual portion weight that deviates from a target portion weight by no more than a predetermined deviation.

5. The method according to claim 1, wherein the first slice thickness is determined to be greater than the second slice thickness only for a partial section of the first product caliber, and for a remaining section of the first product caliber, which corresponds to a total length of the first product caliber minus a length of the partial section, the first slice thickness is set to be identical or substantially identical to the second slice thickness.

6. The method according to claim 5, wherein, after slicing the partial section, the at least two product calibers essentially have a same length.

7. The method according to claim 1, wherein before slicing the at least two product calibers, based on the length of the at least two product calibers, a number of portions is determined into which the at least two product calibers are to be sliced, so that each portion has a predetermined target portion weight or at most a predetermined deviation therefrom.

8. The method according to claim 7, wherein the number of portions, into which at least two product calibers are to be sliced, is further determined taking into account an average actual portion weight of a plurality of portions or all portions that have been sliced previously.

9. The method according to claim 8, wherein the plurality of portions or all portions that have been sliced previously were sliced in a same production batch.

10. The method according to claim 8, wherein the number of portions, into which the at least two product calibers are to be sliced, is increased if the average actual portion weight is higher than the predetermined target portion weight, and/or
the number of portions, into which the at least two product calibers are to be sliced, is reduced if the average actual portion weight is less than the predetermined target portion weight.

11. The method according to claim 1, wherein before or during the feeding, the length is determined by a length measuring unit and/or a weight of the at least two product calibers is determined by a weighing unit.

12. A slicing machine for slicing food products formed as product calibers, comprising:
a feeding unit configured to supply at least two product calibers on adjacent tracks of the feeding unit along a supply direction and individually for each track;
a cutting unit designed to cut the at least two product calibers into slices;
a portioning unit arranged to form portions from the slices cut by the cutting unit, wherein each portion comprises one or more slices; and
a control unit configured to control at least the feeding unit, the cutting unit, and the portioning unit;
wherein the slicing machine is configured to perform the method according to claim 1.

13. The slicing machine according to claim 12, wherein the slicing machine further comprises a gripping unit with at least one gripper, wherein each gripper is configured to grip a product caliber of the at least two product calibers at its end facing away from the cutting unit.

14. The slicing machine according to claim 12, wherein the portioning unit is further configured to convey the portions cut by the cutting unit along a discharge direction to a loading unit, which is configured to supply the portions to a further processing device.

15. The slicing machine according to claim 14, wherein the loading unit is designed as a belt loader.

16. A slicing machine for slicing food products formed as product calibers, comprising:
a feeding unit configured to feed at least two product calibers on adjacent tracks of the feeding unit along a feeding direction and individually for each track;
a cutting unit designed to cut the at least two product calibers into slices,
a portioning unit arranged to form portions from the slices cut by the cutting unit, wherein each portion comprises one or more slices; and
a control unit configured to control at least the feeding unit, the cutting unit, and the portioning unit;
wherein the control unit is configured to determine, based on length of the at least two product calibers, a first slice thickness for a first product caliber of the at least two product calibers and a second slice thickness for a second product caliber of the at least two product calibers, wherein the first product caliber has a greater length before slicing than the second product caliber, wherein the control unit is configured to determine the first slice thickness to be greater than the second slice thickness, and wherein the cutting unit is configured to cut an equal number of portions from the first product caliber and the second product caliber based on the slice thicknesses determined by the control unit so that a length difference between the first product caliber and the second product caliber after cutting will be less than before cutting.
